(19) United States
(12) Patent Application Publication
(10) Pub. No.: US 2014/0108958 A1
(43) Pub. Date: Apr. 17, 2014

(54) TAGGING SYSTEM AND METHOD FOR PROVIDING A COMMUNICATION PLATFORM IN A NETWORK

(71) Applicant: REDPEPPIX. GMBH & CO. KG, Wiesbaden (DE)

(72) Inventors: Torben Toepper, Bad Homburg (DE); Sylvia Klein, Wiesbaden (DE)

(73) Assignee: REDPEPPIX. GMBH & CO. KG, Wiesbaden (DE)

(21) Appl. No.: 13/650,321

(22) Filed: Oct. 12, 2012

(51) Int. Cl. G06F 3/048

(52) U.S. Cl. CPC G06F 3/048
USPC 715/753

(57) ABSTRACT

A tagging system and to a respective method and to a computer program product of providing a communication platform for users of a network, the method including selecting a content object on a webpage from a first user and creating a tag linked to the content object from a first user. The tag is stored in a tag database that's accessible by at least the first user and by at least a second user. Thereafter, the second user is actively or passively informed of the created tag and providing access to the created tag.

### FIELD OF THE INVENTION

The present invention generally relates to tagging of content objects provided in a network, such as the internet, and to sharing of tags related to content objects among a group of users.

### BACKGROUND OF THE INVENTION

Network based communication as for instance provided by the internet is a key for promoting and offering products and services. By means of the internet, an increasing amount of product and service providers acquire customers, which may purchase respective products and services either online or conventionally from respective suppliers.

Advertising of products and services becomes more and more important. However, advertising provided on webpages or on specific platforms in the internet, such as social networks, should in no way annoy or bother potential customers.

US 2010/0023405 A1, which is herein incorporated by reference, refers to advertising by tagging predefined keywords or phrases onto content or media. So-called tags were initially used in programming, as for instance HTML meta tags so that search engines could more easily identify the nature of websites by crawling the website's codes. Nowadays, tags have become an essential ingredient in a variety of websites. Naturally, tags and tagging allows users to identify things and to summarize information.

As described in US 2010/0023405 a user may for instance upload a photo onto a social network. Then, the user may want to tag the photo with what's present in the photo. By clicking on a “tag” button on a specific page, the user may click on a specific area on the photo to tag things being illustrated in said specific area, such as a bag, shoes, etc.

A specific “tag” function of the social network then presents tagging selections in a vertical list or may provide just typing in a phrase. Then, the user is trying to tag her bag in the picture, so that she types in the phrase, “Miu Miu bow satchel coffee addition bag”. The bag is then for instance tagged with “Miu Miu bow satchel coffee addition bag: model: JR-0000xyz”.

An advertising or affiliate marketing network database has the “Miu Miu bow satchel coffee addition bag” in its database, so it sends the particular product information that it has in the database on that particular item.

The data is then sent to the same page that the photo is on and is displayed as a box with additional information like said bags picture, price, dimensions, and production date. At the bottom of the picture a description is provided showing such vendors in a list that carry that particular item.

When a second user comes to look at the first user's picture and finds the item to be interesting, the second user then clicks on one of the vendor's link in the rendered section to check out more information about the item. Then, the second user may find it interesting enough and may decide to purchase the item. Upon this purchase, the first user is paid a commission for linking the items on his page and having them result in a sale.

There, creation of a tag requires, that the user has sufficient access to a photo or that the user is even owner of the photo. Moreover, for displaying the tag to other users, a respective web page comprising or presenting the photo has to be modified in order to present the tag being linked with said photo. Therefore, tagging of photos or other content in the internet so far requires that a tag creating user has respective access rights to modify the page on which the photo is presented.

### BRIEF SUMMARY OF THE INVENTION

In a first aspect, a method of providing a communication platform for users of a network is provided. Here, in a first step, a first user is enabled to select a content object on a webpage. After selecting of the content object, the user may then create a tag linked to said content object. Content objects in the present terminology may comprise text, a picture, arbitrary graphical information, or a movie or video, implemented or shown on a specific webpage. Only non-transitory computer-readable media are within the scope of this application. Non-transitory computer-readable media comprise all computer-readable media except for a transitory, propagating signal.

Creation of a tag requires that the first user selects the content object or a specific portion thereof, which shows a certain product of interest. Hence, the tag then comprises location information about the content object or about a specific portion thereof.

Preferably, the tag comprises a global and/or local location information of the content object or of its content. Global location information may comprise an URL, where the content object (e.g. a picture) is physically located in the internet. Local location information may be indicative of a portion of the content object or of a product or item of interest shown in the content object. Local location information may be indicative of coordinates (x, y) with respect to an origin of the content object. This way, the tag may either be unequivocally linked to the content object itself or to a specific portion thereof.

Creation of a tag also includes adding further information to the tag. Generally, there is no limitation regarding the type and content of such further information. Information to be added to the tag may comprise text, pictures, icons, music files, video files, presentations, production information and so on. By means of this added further information, a user may individually provide user-specific information and messages to a content object, which may be physically located remotely on a host of a content supplier.

The tag thus created by the first user is then stored in a tag database being accessible by at least the first user and by at least a second user. After being stored in the tag database, the second user is directly informed of the created tag. Moreover, direct access to the created tag is provided to the second user.

This way, first and second users may use the tag database and the setting and sharing of tags to communicate with each other in a rather unconventional but very intuitive way. Hence, the first user may identify a content objection somewhere on the internet and may create a respective tag by selecting said content object and by posting a comment related thereto. After having created such a tag, the created tag can be directly forwarded to a second user, which is instantly informed about the tag creation.

By actively or passively presenting the tag to the second user, the user may select and activate the respective tag and may then be automatically forwarded and guided to the content object to which the tag is linked. It is of particular benefit here, that the remotely located content object is displayed to the second user together with the tag information created by the first user. Hence, the second user can be instantly informed about the information posted by the first user in relation to the selected content object. Preferably this additional information comes along with a hyperlink, effectively providing a target (e.g. an internet shop) to which the second user will be instantly directed for purchasing the item of interest advertised by the tag.

In a further step, first and second users may swap roles and may use the created tag as a communication platform. Hence, the second user may be enabled to modify or to complement the tag created by the first user. Once the modified tag has been stored in the tag database, the first user may be correspondingly informed about the tag modification. This way, first and second users may communicate tag-based via a tag database, typically provided by a tag provider.

It is of particular benefit here, that neither the first nor the second user nor any other user of the communication platform is required to operate a tag database by himself. Preferably, the tag database is provided by a tag provider, to which first and second users have subscribed. Tags created or modified by first and/or second users are therefore physically located in said tag database. By means of the tag database, the original or genuine content object provided on a remote and/or arbitrary webpage does not have to be modified but can be provided to the second user in a rather conventional way.

Since the second user is connected to the tag database, illustration of the tagged content object to the second user can be automatically tracked by the tag provider and/or by the tag database, thereby triggering the displaying of respective tag information to the second user together with the content object.

In this way, the described method and a corresponding tagging system provide an architecture allowing to virtually modify remote webpages and their content objects without having respective access rights to do so. The tag database together with the tag provider effectively provides a virtual mask or overlay which automatically pops up with the first and/or with the second user if a tagged content object is to be displayed to first and/or second user, respectively.

In another embodiment, the second user is automatically notified when the first user creates or modifies a tag. Preferably, first and second users are members of a social network, wherein first and second users are typically linked to each other. In terms of the social network, first and second users may be “friends”, thereby expressing the intension to mutually inform about and to share activities, opinions and interests. When subscribing to the tag database, first and second users may specify, which kind of tags should be shared with other users. Moreover, subscribing to the tag database may exploit an already existing social network, to which first and second user already belong.

In another embodiment, the content object, to which a tag may be linked comprises a text, a picture, a movie and/or a hyperlink. The content object forming a base for a tag should be visually presentable in order to identify at least a portion thereof to which a tag may be created.

In a further embodiment, the tag comprises at least a unique tag identification being indicative of the content object and in particular of its physical location. The tag further comprises at least tag data which is created or selected and/or provided by the first user. Regarding the tag data there is generally no limitation regarding the type and content thereof. The tag data may comprise comprise text, comments, pictures, icons, music files, video files, presentations, production information or the like.

In a further embodiment, the tag data may be indicative of a product or a service which is somehow illustrated or interlinked with the content object shown on a remote webpage. Here, the tag database may provide a product and service database including a multiplicity of product and service information regarding products and services obtainable from department stores or comparable online stores and service providers.

Hence, when creating a tag, the tag database may already suggest certain keywords and categories to facilitate identification of a product of interest illustrated on the content object. If the content object (e.g. a picture on an arbitrary webpage) shows a product of interest, such as a wrist watch of type A of manufacturer B of retailer C together with a price information D, all these pieces of information A, B, C, D may be included into the tag data and may be presented to the second user on demand, when the second user may be interested in the product of interest and in the advertising message provided by the respective tag.

Upon creation or modification of a tag, the tag database may provide a search functionality in order to correctly identify a product of interest. This way, the tags individually set by users subscribed to the tag database may be used as an advertisement tool to selectively provide detailed information of a product of interest to another user of the network.

In a further embodiment, the first user and/or the database provider is rewarded with a commission in response to the second user following the tag. Following of the tag may be separated and may include different tag following scenarios. The tag may be followed by simply viewing the content of the tag, by clicking on the tag to be forwarded to a merchant's homepage which the tag is indicative of, or finally when the tag reading user actually purchases a product or service related to the tag. The commission to be provided to the tag setting user and/or to the tag database provider may strongly depend on the following scenario. A payment or commission for the user and/or the provider may be based on earnings per view (epv), earnings per click (epc) and/or earnings per purchase (epp).

Preferably, the tag data not only provides abstract and objective product-related information but also respective subjective information or recommendations about preferred retailers or shops, where the advertised product can be purchased. If the second user purchases a product of interest being previously advertised by a tag created by the first user, the first user will be rewarded with a commission for advertising the product to the second user.

This way, users and subscribers of the database are encouraged to create a multiplicity of tags together with product or service advertisement to other users of their social network. Submission of tags, which takes place either actively or passively through the network of subscribed users of the database, is preferably logged and stored either in the database itself or by the database provider. In this way, purchase of a service or product advertised by a tag submission can be effectively tracked, at least for a predefined period of time, so that advertisement- and tag-related purchase events can be precisely identified for calculating and distributing respective commissions to the users.

In another aspect a tagging system is provided which is adapted to provide a communication platform to at least two subscribers of a tag database. The tagging system comprises a first tag extension application installed or to be installed on a first user's electronic device, and a second tag extension application installed or to be installed on a second user's electronic device. Furthermore, the tagging system comprises a tag provider to store and to provide at least one tag. Typically, the tag provider runs a tag database, in which a plurality of individually created tags are stored, modified and/or provided to any arbitrary user thereof. Electronic devices may include but are not limited to computers, tablet computers, mobile phones, smartphones, television devices, and the like.

Furthermore, the at least first and second users are subscribers of the tag provider. The first and/or the second tag extension application is or are further operable to set, to modify, to read, and/or to share at least one tag in a tag database of the tag provider. Such a tag is further linked to a content object on an arbitrary webpage, which may even be located at a remote location and which may be provided by a third party, to which neither the first user nor the second user nor the tag provider may have access to.

Preferably, the tag extension application comprises a browser extension to be installed with an internet browser of first and/or second user's computer. By means of installing the extension application as first and second tag extension to first and second users, respectively, the browsing behavior of respective web browsers can be modified in such a way, that tagged content objects on arbitrary webpages are at least identified and indicated with an icon or with a similar identifier illustrating that the respective content object is linked with a tag.

Distribution of tags among users and subscribers of the tag provider may be conducted either passively or actively. Active distribution requires, that created tags are either manually or automatically transmitted between selected users or subscribers of the tag provider. Since the community of subscribers or the number of “friends” of a particular user may exceed a manageable number, the various users may individually specify and select only a limited amount of users of particular interest. Then, tag-related actions of a user will be forwarded and displayed only to the selected users.

Generally, users subscribed to the tagging system may individually specify global and/or local user setting. Hence, any user may specify in a respective user profile if and in how far created tags will by automatically or manually distributed to various selected users or to all users of the first user's social network. But also regarding receipt of tags and tag notifications, any use may specify whether tags set and/or posted by other users pop-up automatically or only upon request. In this context also the second user may specify that he only wants to be informed of tags set by a selected user or by a predefined group of users. In a further embodiment, the first and/or the second tag extension application is or are operable to automatically notify at least the second user in response to the first user creating a tag. This way, a rather active and instant as well as wide distribution of created tags can be provided.

A passive distribution of tags does not require any individual messages to be sent between users and subscribers of the tag provider. Instead, tagged content objects are simply annotated and indicated with a small icon in for instance an upper left corner of the content object. By means of such an icon, a user subscribed to the tagging provider and browsing on a webpage featuring the tagged content object is simply informed that respective content object has been tagged by an unknown user, which is also subscriber of the tag provider. Then it is up to the browsing user to further inspect the content object and its related tag according to his own interest.

This approach even allows complementing of a large number of content objects with product- or service-related additional information, which is to be displayed to a user only on demand. In this way, a rather unobtrusive advertising can be presented on an unlimited amount of webpages. Moreover by way of the passive distribution, tags may also be shared among an anonymous group of users that do not know about each other.

In a further preferred embodiment, the tag database of the tagging system is operable to store tags being linked to content objects (e.g. pictures) provided by a third party content supplier.

Respective tags and content objects may be unequivocally identified by a physical address or location of the content object. Even when a respective content object may show up on a different webpage, or at a later stage, then the respective tag linked thereto will automatically be present again.

In still another aspect, also a computer program product is provided on a computer-readable medium. The computer program product is operable to provide a method of providing a communication platform for use of a network, especially by making use of a tagging system as described above. Said method being implementable by the computer program product comprises the steps of:

selecting of a content object on a webpage by a first user,

creating a tag linked to the content object by the first user,

storing the tag in a tag database being accessible by at least the first user and by at least a second user, and

actively or passively informing the second user of the created tag and providing direct access to the created tag.

Preferably, the computer program product comprises a tag extension application to be installed as a browser extension of an internet browser of a first and/or of a second user.

The computer program product furthermore comprises and provides a subscription tool, by way of which users may subscribe to the tag provider and to the tag database. Once registered to the tag provider and to the tag database, the respective tag extension applications are operable to communicate with the tag database and to modify the appearance of a browser window when a webpage to be illustrated in the browser window comprises a content object linked with a tag stored in the tag database.

This way, the computer program product and the tagging system provide a virtual mask or a virtual overlay to complement the content of a remote genuine webpage with tag-based information created and exploited by the users and subscribers of the tag database.

It is further to be noted here, that various aspects, benefits and features as described in connection with the method of providing a communication platform also apply to the tagging system and to the computer program product; and vice versa.

It is therefore an object of the present invention to provide an improved tagging system, a respective tagging software as well as a method to provide tagging-based communication among users of a network allowing for a more flexible creation and modification of tags.

### BRIEF DESCRIPTION OF THE DRAWINGS

FIG. 1 to FIG. 6 generally show a method of providing a communication platform for users of a network;

FIG. 1 schematically illustrates the tagging system in a block diagram;

FIG. 2 schematically shows the data structure of the database and tags stored therein;

FIG. 3 shows a conceivable structure of a user management implemented by the tag provider;

FIG. 4 schematically illustrates the appearance of a web browsing window of a first user during creation of a tag;

FIG. 5 schematically shows a browser window of a second user being notified of a tag creation of the first user; and

FIG. 6 schematically illustrates a flowchart of various steps conducted by the first and by the second user when creating and using respective tags.

### DETAILED DESCRIPTION

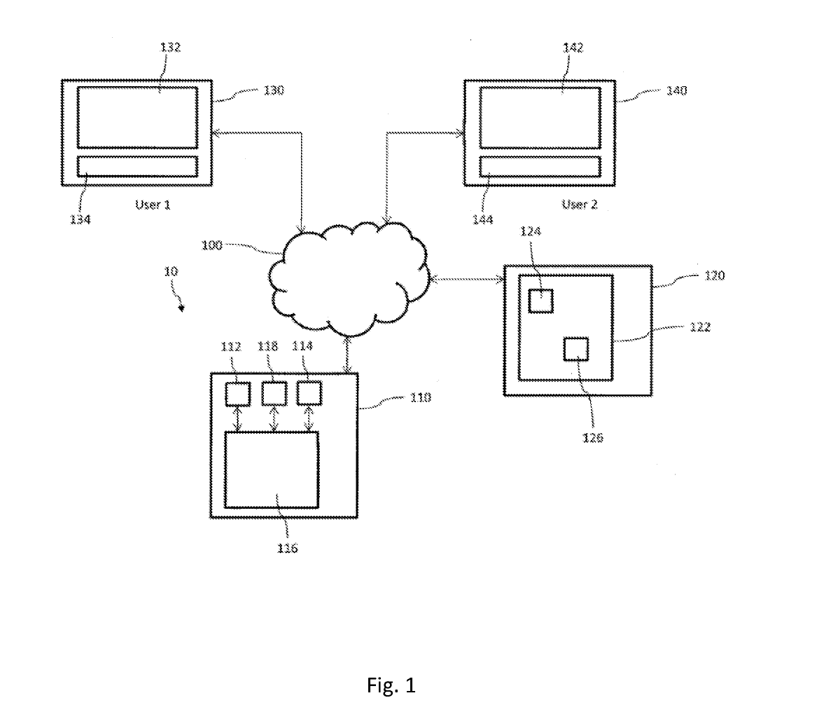

The tagging system 10 as illustrated in FIG. 1 requires a network 100, such as the internet. Moreover, the tagging system 10 comprises at least a tag provider 110 providing a tag database 116, that serves to store, to modify, and to distribute arbitrary tags and tag-related information.

The tagging system 10 further comprises a tag extension 134, 144 or tag extension application to be installed with a browser 132, 142 of a first user 130 and of a second user 140, respectively.

The first user 130 as well as the second user 140 may use their internet browsers 132, 142 in a rather conventional way. The first user 130 may for instance browse through a webpage 122 provided by a content supplier 120. The webpage 122 may comprise two content objects 124, 126, in the form a picture or photograph. If the first user 130 identifies a product or service of interest or some other arbitrary but visually displayed item, on the content object 124, said first user 130 may initiate creation of a tag 200.

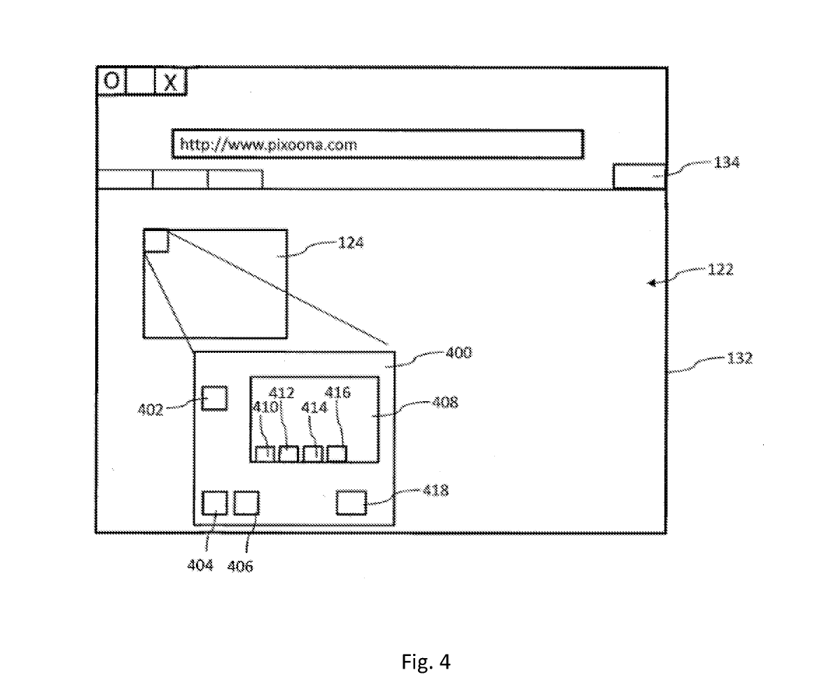

By means of the tag extension application 134, and as for instance illustrated in FIG. 4, the first user 130 may either select the content object 124 or a portion thereof as a basis for the tag 200 to be created. In response of a tag initiating or tack creation command, the tag extension application 134 may provide an entry mask 400. There, an icon 402 related to the identity of the user 130 may be provided together with an editor window 408, in which the first user 130 may enter any kind of information, such as a recommendation to a friend.

The editor window 408 may further be provided with various function buttons 410, 412, 414, 416. By means of the various buttons 410, 412, 414, 416 the text entered into the editor window 408 may either be edited, regarding font style and font size. Moreover, the various buttons 410, 412, 414, 416 may provide additional functionalities, such as embedding particular files into the tag, including music files, document or presentation files or a movie files. Moreover, a button 412 may also be selected to enter a product identification procedure, by way of which the tag provider 110 can provide various categories representing product type, manufacturer, retailer and price regarding a product of interest as illustrated in the content object 124.

By means of a submit button 418, the created tag 200 can be submitted to the tag provider 110 and can be stored in the tag database 116. Additionally, the entry mask 400 may provide at least one share button 404, 406, by way of which the user 130 may select at least a single one or a predefined group of related second users 140 to be automatically notified about the creation and setting of the tag 200. The share buttons 404, 406 may be directly linked to a predefined group of users, as they are present in the first user's 130 social network.

By sharing the tag 200 directly upon its creation, an interactive and tag-based communication among users 130, 140 and subscribers of the tag provider 110 can be launched. Once the tag 200 has been created and submitted to the tag database 116, a second user 140 may be instantly notified about the tag-setting event of the first user 130.

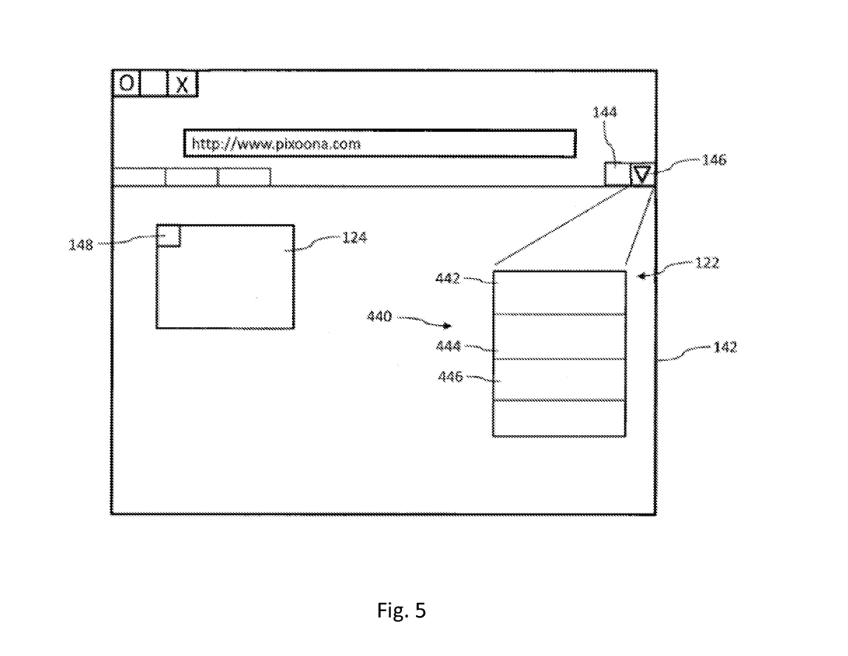

FIG. 5 schematically illustrates a respective browser window 142 of the second user 140. There, the tag extension application 144 is visible in an upper right corner and may visually indicate to the second user 140, that a tag setting event of a related first user 130 has recently occurred. Hence, the second user 140 may press on an expansion button 146, thereby initiating illustration of a pop-up menu 440. In the drop-down menu 440 various notifications or messages 442, 444, 446, all related to at least one or several tags 200 set by the first user 130 or by any other additional users are presented.

The individual messages 442, 444 and 446 may directly provide a link, preferably a hyperlink either to the original content object 124 to which the respective tag 200 is linked to. Alternatively or additionally, the tag data stored in the created tag 200 may be indicative of a target representing for instance a homepage of a retailer where a certain product of interest can be purchased. Such target information about the product of interest may be directly implemented in the messages 442, 444, 446. This way, the second user 140 may be directly directed or forwarded to a retailer's webpage when clicking on the respective notification message 442, 444, 446.

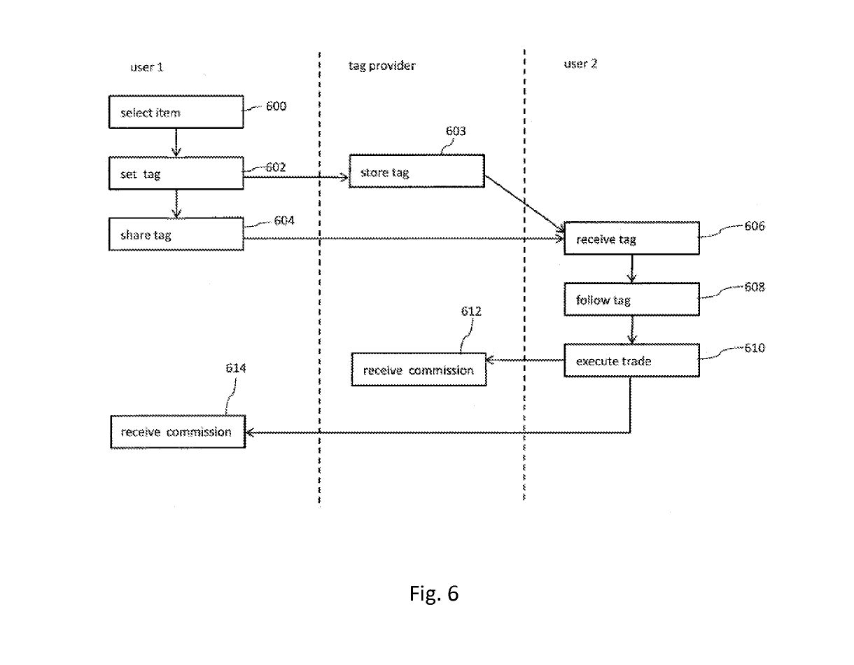

It is to be noted that the screenshots as shown in FIGS. 5 and 6 are only of exemplary nature. The position and style of various items and graphical elements to show up on within a browser window may strongly depend on the type and version of the browser and on the individual setting of the respective user.

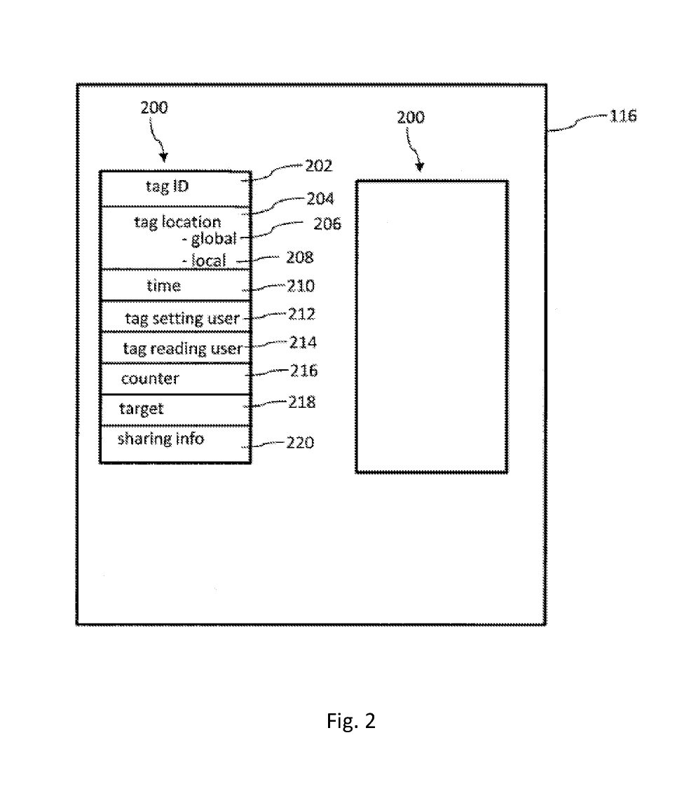

In FIG. 2, an exemplary data structure of a tag 200 as stored in the tag database 116 is illustrated. The tag 200 comprises a unique tag ID 202, by means of which the tag 200 can be identified. Typically, the tag ID 202 is provided with location information 204, where the related content object 124 is physically located. The location information 204 may further split into global location information 206 and local location information 208.

The global location information 206 is for instance indicative of the URL of the webpage 222 on which the content object 124 is illustrated. Additionally, the global location information 206 may be indicative of a unique physical address of the content object 124 itself.

The local location information 208 may be indicative of the exact position of the tag 200 within or relative to the content object 124. Given that the content object 124 is rather large and shows for instance a multiplicity of items or products of interest, the local location information 208 may indicate a particular position in the content object 124, where a product of interest is shown. The local location information 208 may therefore provide two-dimensional coordinates (x, y) relative to a place of origin or to a reference point of the content object 124.

Additionally, the tag 200 is typically provided with a time information 210 being indicative about the time of creation of the respective tag 200. Additionally, the time 210 may be indicative of the various points of time at which the tag 200 has been presented to other users of the tagging system 10.

Additionally, the tag 200 comprises a tag setting user field 212 as well as a tag reading user field 214. In these data fields, respective identifications of a tag setting or tag creating user as well as of a tag reading user can be stored.

In another data field 216, a tag counter is implemented being indicative how often the respective tag has been visited by users 130, 140 of the tagging system 10. Additionally, the tag 200 comprises a target field 218 which is to be individually modified by the tag creating user 130. The target field 218 may be operable to store user-specific information about the respective tag 200. For instance, product-related information, like product type, product manufacturer, product retailer or product price can be stored in the target field 218. Hence, the target field may store any kind of rich content including hyperlinks to retailer shops as well as media files, such as picture files, video files and/or music files.

By means of the target field 218, which is to be displayed together with the tag 200 to other users 140, the subscribing users 130, 140 of the tagging system 10 may freely communicate with each other on the basis of a selected content object 124, to which the tag 200 relates to.

In another field 220, sharing information regarding the respective tag 200 can be stored. For instance, the sharing field 220 may comprise a flag, whether said tag is to be automatically shared or notified to other subscribed and pre-defined users. Setting of a respective flag may be triggered by the share buttons 404, 406 as illustrated in FIG. 4.

Once a user 130 has created a tag 200 stored in the database 116, the second user 140, as illustrated in FIG. 1 may be either automatically notified about the recent tag creation. Independent of an active distribution of a created tag among users 130, 140, a second user 140 may be also passively informed about a tag creation. If for instance the second user 140 visits the same webpage 122, on which the first user 130 has already created a tag 200, the second user 140 will be informed about an existing tag on the remote webpage 122 by means of the tag extension application 144.

When browsing through the internet, the tag extension application 144 will constantly analyze the content of webpages 122 and will synchronize the content of such webpages 122 with the content of the tag database 116. If the user 140 coincidentally browses through a webpage 122 having a tagged content object 124, the tag extension application 144 will automatically transmit identifiers and/or locations of content objects 124, 126 retrieved on said webpage 122 to a tag reading module 114 of the tag provider 110.

The tag reading module 114 will then scan the tag database 116 and will return a respective tag 200 when the content object 124 as illustrated on the webpage 122 matches with a content object 124 stored in the tag database 116. In case of such a match, the tag extension application 144 may just supply an icon 148 to the content object 124 when displayed on the browser window 142 of the second user 140. Hence, the tagging system 10 only smoothly modifies the content of the original webpage 122 for not annoying the second user 140 with advertisement.

By providing only a small icon 148 in a specific corner of the content object 124, the second user 140 can be sufficiently notified, that at least one tag is related to the content object, which tag together with respective tag information can be presented to the user on request. When clicking onto the icon 148, respective tag information and tag data will be automatically provided to the second user 140 by generating a separate mask or a dialog window on the second user's 140 screen.

The tag provider 110 further comprises a tag writing module 112, by way of which the users 130, 140 may individually create tags 200 related to arbitrary content objects 124, 126, which may even be present and located in a remote location of a content supplier 120. Additionally, the tag provider 110 comprises a user management 118, by means of which user-related data can be stored, managed and processed.

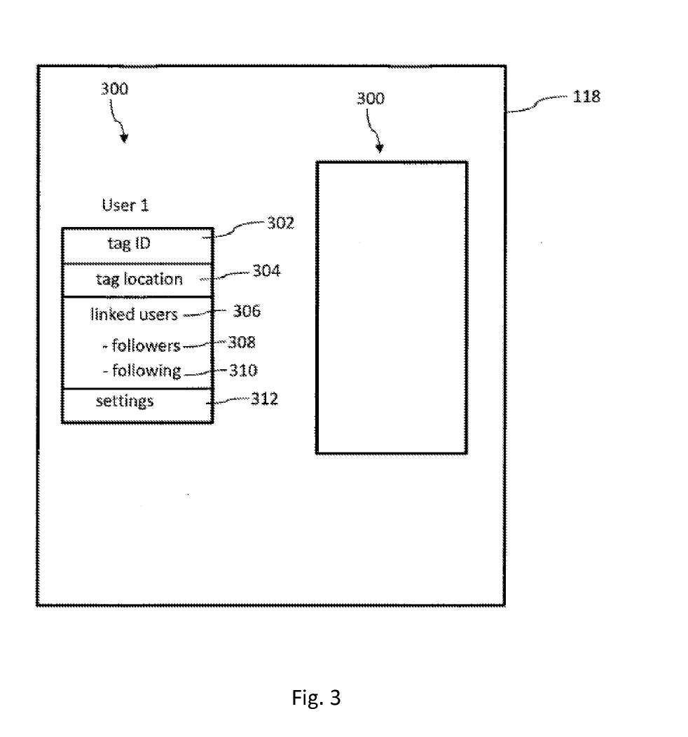

As shown in FIG. 3, a user profile 300 as stored in the user management 118, comprises a user ID 302, by means of which a user may authenticate to the tag provider 110. Typically, the ID 302 is assigned to a password for inhibiting unauthorized access to the tag provider 110.

The user profile 300 further stores a number of tags 302 which are either created by the respective user or which have been clicked by said user. Furthermore, the user profile 300 may comprise a list 306 of linked or interrelated users. Among those, there may be a list 308 of users following the present user. Additionally, a further list 310 might be provided listing all those users whom the actual user follows.

Additionally, the user profile comprises a list 312 of various settings, which may be modified according to the individual preferences of the respective user.

The flowchart of FIG. 6 is indicative of a typical tag creation and tag reading procedure. There, in a first step 600 a first user 130 may select an item (e.g. retrieved on a content object 124) as displayed on an arbitrary webpage 122. Then, in a following step 602, the respective user 130 may create or set a respective tag 200. The created tag is then stored in step 603 in the tag database 116 of the tag provider 110. Thereafter, the stored tag 200 may either be actively or passively distributed in step 604 to a different user 140 as already described above. Distribution or sharing of a stored tag 200 can be performed either actively or passively. Distribution of a tag may be automatically conducted while the tag is stored in the database. Hence, storage and distribution of tags can take place instantaneously and at the same time. Alternatively or additionally it is conceivable, that a created and stored tag is distributed later on by the tag setting user. In this way, created and stored tags could be distributed to various users several times and chronologically staggered compared to the tag setting event.

When the second user 140 in step 606 receives a tag notification, he may in a following step 608, select the respective tag. Tag selection as well as tag notification may be tracked and recorded by the tag provider 110. If the tag comprises for instance an advertising recommendation regarding a certain product of interest, the second user 140 may be provided with retail details of the respective product. If the second user 140 then executes a recommended trade in section 610, the respective trade process will generate a commission, which in steps 612 and 614 will be shared among the tag provider 110 and by the first user 130 which previously set the respective tag 200. It is to be noted here, that generation of a commission may not only be based on a trade or purchase activity of the second user. A commission for the tag provider and/or for the recommending user may also evolve when the second user follows the recommendation, by simply clicking on a provided hyperlink.

While the invention has been described in detail herein in accordance with certain embodiments thereof, many modifications and changes may be effected by those skilled in the art without departing from the spirit of the invention. Accordingly, it is intended that the appended claims not be limited by way of details and instrumentalities describing the embodiments shown herein.

What is claimed is:

1. A method of providing a communication platform for users of a network, the method comprising the steps of:
selecting a content object on a webpage by a first user;
creating a tag linked to the content object by the first user;
storing of the tag in a tag database, accessible by at least the first user and by at least a second user; and
actively or passively informing the second user of the created tag and providing direct access to the created tag.

2. The method according to claim 1, wherein the second user is automatically notified when the first user creates or modifies a tag.

3. The method according to claim 1, wherein the first and the second users are members of a social network.

4. The method according to claim 1, wherein the content object comprises a text, a picture, a video clip and/or a hyperlink.

5. The method according to claim 1, wherein the tag comprises:
a unique tag identification being indicative of the content object; and
at least tag data created, selected or provided by the first user.

6. The method according to claim 5, wherein the tag data is indicative of a product or service illustrated by or related to the content object.

7. The method according to claim 6, wherein the first user is rewarded with a commission in response of the second user following the tag.

8. A tagging system adapted to provide a communication platform, comprising:
a first tag extension application installed on a first user's computer;
a second tag extension application installed on a second user's computer;
a tag provider to store and to provide at least one tag; and
wherein the at least first and second users are subscribers of the tag provider and wherein the first and/or second tag extension applications are operable to set, to modify, to read and/or to share at least one tag in a tag database of the tag provider, wherein the tag being linked to a content object on a webpage.

9. The tagging system according to claim 8, wherein the first and/or the second tag extension application is operable to automatically notify at least the second user in response to the first user creating or modifying a tag.

10. The tagging system according to claim 8, wherein the tag database is operable to store tags linked to content objects provided by third party content suppliers.

11. A computer readable medium having computer readable instructions stored thereon for execution by a processor to perform a method comprising the steps of:
selecting a content object on a webpage by a first user;
creating a tag linked to the content object by a first user;
storing of the tag in a tag database, accessible by at least the first user and by at least a second user; and
actively or passively informing the second user of the created tag and providing direct access to the created tag.
